(19) United States
(12) Patent Application Publication
(10) Pub. No.: US 2009/0155921 A1
(43) Pub. Date: Jun. 18, 2009

(54) METHOD AND APPARATUS FOR READING TEST STRIPS

(75) Inventors: Peter S. Lu, Mountain View, CA (US); Joseph Byerly, Pebble Beach, CA (US); Christopher Kepner, Campbell, CA (US); Thomas M. Sherlock, Los Altos, CA (US); Michael P. Belmares, San Jose, CA (US); Johannes Schweizer, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arbor Vita Corporation, Sunnyvale, CA (US)

(21) Appl. No.: 12/333,219

(22) Filed: Dec. 11, 2008

Related U.S. Application Data
(60) Provisional application No. 61/013,634, filed on Dec. 13, 2007.
(60) Provisional application No. 61/013,299, filed on Dec. 12, 2007.

(51) Int. Cl. G01N 21/75; G01N 21/00

(52) U.S. Cl. 436/164; 422/55

(57) ABSTRACT

The present invention provides a method and apparatus for reading test strips such as lateral flow test strips as used for the testing of various chemicals in humans and animals. A compact and portable device is provided that may be battery powered when used remotely from the laboratory and, may store test data until it can be downloaded to another database. Motive power during scanning of the test strip is by means of a spring and damper that is wound by the operator during the insertion of a test strip cassette holder prior to test.

### CROSS-REFERENCES TO RELATED APPLICATIONS

This application claims the benefit of U.S. provisional application 61/013,299 filed on Dec. 12, 2007 entitled “Method and Apparatus for Reading Test Strips” and U.S. provisional application 61/013,634 filed on Dec. 13, 2007 entitled “Method and Apparatus for Reading Test Strips”, and the content of both of these applications is hereby incorporated by reference in its entirety and for all purposes.

### BACKGROUND OF THE INVENTION

Test strips, as used in the detection of pregnancy, infection, drugs or other constituents of human fluids, can be read by eye or by machine. Some tests, by their nature are easily read by eye because the chemical reaction between the components on the test strip causes great enough color changes at specific points on the strip that the contrast with the background is easily visually discernable Other strip tests are more appropriately read by machine if the contrast between an area of indication and the background is slight or if the decision as to whether a test is positive or negative rests in an algorithm that compares relative reflectance values of multiple areas along the test strip. Typically, the devices that read test strips are expensive and relatively large, restricting their use to the lab or clinical setting.

### BRIEF SUMMARY OF THE INVENTION

The present invention provides a portable device for accurately determining a test result from a test strip. Such a test strip reader comprises a light source that illuminates at least part of a test strip; a transport mechanism that moves the test strip past the light source, the transport mechanism further comprising a spring that propels the test strip and a damping mechanism that limits the speed of transport; a sensor that produces a signal indicating the intensity of light reflected from the test strip; electronic circuitry configured to repeatedly measure a quantity of light reflected from the test strip and to produce for each measurement a digital value representing the measured light quantity; and a processor configured to determine, based on the digital values, a test result. In some embodiments, the sensor is a first sensor, and the test strip reader further comprises a second sensor that produces a signal indicating the brightness of the light source, and the electronic circuitry is further configured to also measure the signal from the second sensor and to adjust the digital values to compensate for variability of the brightness of the light source. The second sensor may sense the brightness of the light source directly, or may sense the intensity of light reflected from a reference strip. The reference strip may also be moved by the transport mechanism.

The test strip reader may further comprise a battery that powers the electronic circuitry. The test strip reader may comprise an indicator that indicates the test result. The test strip reader may comprise an encoder that indicates progress of the transport mechanism by producing a series of position-indicating signals related to the position of the transport mechanism, and the measurements of light intensity signal may occur upon receipt by the electronic circuitry of at least some of the position-indicating signals. The test strip reader may comprise a bar code reader that reads a bar code from a cassette holding the test strip. The test strip and bar code may reside on opposite sides of the cassette.

The test strip reader may further comprise a display upon which test results are displayed. The display may be a liquid crystal display, and may be a touch screen display. The test strip reader may comprise at least on input/out port connector. The test strip reader electronic circuitry may further comprise a memory in which test data are stored for later communication to an external computer system via at least one of the input/output connector. The test strip reader may comprise a removable memory.

The test strip reader may comprise a reading optical system that directs light reflected from the test strip to the sensor, and the reading optical system may comprise at least one lens element. The reading optical system may comprise at least one spherical lens element. The spherical lens element may comprise a transmission band having a polished surface, and the remainder of the surface of the spherical lens element may be configured to reduce stray light reflections. The remainder of the surface of the spherical lens element may have a matte finish and may be covered with a light-absorbing coating. The reading optical system may comprise a semi-cylindrical lens element proximate the sensor, and may comprise an aperture placed immediately in front of the sensor. The aperture may be a slit aperture having a width of between 0.025 inches and 0.035 inches (0.64 millimeters and 0.89 millimeters).

The damping mechanism may be a rotary damper. The light source may illuminate the test strip from a direction substantially perpendicular to the test strip surface.

In another embodiment, a test strip reader comprises a light source that illuminates at least part of a test strip; a mechanically-powered transport mechanism that moves the test strip past the light source; electronic circuitry comprising a processor and configured to repeatedly measure a quantity of light reflected from the test strip, to produce for each measurement a digital value representing the measured light quantity, and to determine a test result based on the digital values; and a battery that supplies power to the light source and electronic circuitry.

In another embodiment, a method of ascertaining a test result comprises receiving a test strip to which a test fluid has been applied; reading the reflectance of the test strip at multiple locations along the test strip by mechanically transporting the test strip past a reading location in a battery-powered test strip reader; recording a digital value for each reflectance reading; ascertaining a peak or minimum reflectance value in each of one or more regions of the test strip; comparing the peak or minimum reflectance values with a predetermined set of interpretation rules to determine the test outcome; and communicating the test outcome. Transporting the test strip further may further comprise moving a tray carrying the test strip under the action of a spring, and the method may further comprise limiting the speed of transport by a mechanical damper actuated by motion of the tray. The method may further comprise illuminating the test strip and reading an intensity of light reflected from the test strip.

In another embodiment, a test strip reader comprises a base portion housing a mechanical transport mechanism including a spring and a damper; an upper portion housing an illumination source that illuminates a test strip under test, a sensor that detects light reflected from the test strip, an electronic circuit that controls operation of the test strip reader, and a display on which test results are shown to a user of the test strip reader. The test strip under test resides above the base portion, and is transported by the transport mechanism beneath the light source during reading of the test strip. The display may be positioned at an angle of between 30 and 60 degrees from horizontal. The test strip reader may further comprise an encoder that produces signals indicating a position of the transport mechanism, and the intensity of the light reflected from the test strip may be measured upon receipt by the electronic circuit of at least some of the position-indicating signals.

The display may be a touch screen display. The test strip reader may further comprise a movable tray that holds a cassette, which in turn holds the test strip under test. The movable tray may be configured to accommodate cassettes of different sizes and from different test manufacturers. The test strip reader may further comprise a gear rack on the movable tray and a rotary damper in the base portion including a pinion gear, with the gear rack engaging the pinion gear during reading of the test strip.

The test strip reader may further comprise a bar code reader in the base portion, wherein the barcode reader reads a barcode from a cassette that holds the test strip in conjunction with reading of the test strip.

The light source of the test strip reader may be a light emitting diode. The test strip reader may further comprise an illumination optical system that enhances the level of illumination of the test strip. The illumination optical system may comprise at least one spherical lens element and at least one hemispherical lens element.

The test strip reader may further comprise a reading optical system that directs at least some of the light reflected from the test strip to the sensor. The reading optical system may comprise at least one spherical lens element, and may comprise at least one semi-cylindrical lens element. The sensor may be a first sensor, and the test strip reader may further comprise a second sensor that senses illumination from the light source directly, wherein the electronic circuit is configured to adjust measurements of reflected light taken from the first sensor, based on direct measurements of light intensity taken from the second sensor, to compensate for variations in the intensity of the light source during reading of the test strip.

The test strip reader may comprise a battery that powers the electronic circuitry. The electronic circuitry may be configured to repeatedly take measurements of the light reflected from the test strip during reading of the test strip, convert the measurements to digital values, and to apply a predetermined set of interpretation rules to the digital values in order to determine a test result. The electronic circuitry may comprise a memory in which test data are stored for later retrieval, and the memory may include a removable memory.

### BRIEF DESCRIPTION OF THE DRAWINGS

FIG. 1 shows an exploded view of the optical and electronic components of a test strip reader in accordance with an example embodiment of the invention.

FIG. 2 shows an exploded view of the base and transport mechanism of a test strip reader in accordance with an example embodiment of the invention.

FIG. 3 shows the assembled reader with one wall cut away to show the internal parts, in accordance with an example embodiment of the invention.

FIGS. 4A-4D show upper left, lower left, upper right, and lower right portions respectively of a schematic diagram of the electronic circuit of a test strip reader in accordance with an example embodiment of the invention.

FIG. 5 shows an optical path for a test strip reader in accordance with another example embodiment of the invention.

FIG. 6 shows an example graphical representation of test data gathered from a test strip by a reader according to an example embodiment of the invention.

FIG. 7 shows a flowchart of the process for reading a test strip designed to detect the presence or absence of avian influenza, in accordance with an example embodiment of the invention.

FIG. 8 shows the external appearance of a test strip reader in accordance with another example embodiment of the invention.

FIG. 9 shows another view of the example reader of FIG. 8.

FIG. 10 shows a cutaway side view of the example reader of FIG. 8.

FIG. 11 shows an end view of the transport mechanism and other components in the example reader of FIG. 8.

FIG. 12 illustrates a simplified block diagram of the electrical and electronic systems of the example reader of FIG. 8.

### DETAILED DESCRIPTION OF THE INVENTION

The term “test strip” as used herein refers to any medium used horizontally or vertically to accomplish a bioassay, drug test, pregnancy test or other test reliant on the transport of a fluid through or across that medium for the purpose of detecting various constituents of the fluid.

Lateral flow devices are a preferred format. Similar to a home pregnancy test, lateral flow devices work by applying fluid to a test strip that has been treated with specific biologicals. Carried by the liquid sample, the biologics are labeled and flow through the strip and can be captured as they pass into specific zones. The amount of label found on the strip is proportional to the amount of the target analyte. The lateral flow typically contains a solid support (for example nitrocellulose membrane) that contains three specific areas: a sample addition area, a capture area, and a read-out area that contains one or more zones, each zone containing one or more labels. The lateral flow can also include positive and negative controls. Thus, for example a lateral flow device can be used as follows: target proteins are separated from other proteins in a biological sample by bringing an aliquot of the biological sample into contact with one end of a test strip, and then allowing the proteins to migrate on the test strip, e.g., by capillary action. Proteins, antibodies, and/or aptamers are included as capture and/or detect reagents. Methods and devices for lateral flow separation, detection, and quantification are known in the art, e.g., U.S. Pat. Nos. 6,942,981, 5,569,608; 6,297,020; and 6,403,383 incorporated herein by reference in their entirety.

One form of a lateral assay is a PDZ (Psd-95, D1g, and ZO1 proteins) capture assay. In such an assay, a PDZ protein or one antibody or population of antibodies is immobilized to a solid phase as a capture agent, and another antibody or population of antibodies or a PDZ protein in solution is as detection agent. In one format, a test strip comprises a proximal region for loading the sample (the sample-loading region) and a distal test region containing a PDZ protein capture reagent and buffer reagents and additives suitable for establishing binding interactions between the PDZ protein and any PL (PDZ ligand) protein in the migrating biological sample. The selection of PDZ capture reagent and antibody detection reagent depends on the target. Typically, the detection agent is labeled, such as with gold. If an antibody population is used, the population typically contains antibodies binding to different epitope specificities within the target antigen. Accordingly, the same population can be used for both capture agent and detector agent. If monoclonal antibodies are used as contact and detection agents, first and second monoclonal antibodies having different binding specificities are used for the solid and solution phase. Capture and detection agents can be contacted with target antigen in either order or simultaneously. If the capture agent is contacted first, the assay is referred to as being a forward assay. Conversely, if the detection agent is contacted first, the assay is referred to as being a reverse assay. If target is contacted with both capture agent and detection agent simultaneously, the assay is referred to as a simultaneous assay. After contacting the sample with capture and detection antibodies, a sample is incubated for a period that usually varies from about 10 min to about 24 hr and is usually about 1 hr. A wash step can then be performed to remove components of the sample not specifically bound to the detection agent. When capture and detection agents are bound in separate steps, a wash can be performed after either or both binding steps. After washing, binding is quantified, typically by detecting label linked to the solid phase through binding of labeled solution antibody. Usually for a given pair of capture and detection agents and given reaction conditions, a calibration curve is prepared from samples containing known concentrations of target antigen. Concentrations of antigen in samples being tested are then read by interpolation from the calibration curve. Analyte can be measured either from the amount of labeled solution antibody bound at equilibrium or by kinetic measurements of bound labeled solution antibody at a series of time points before equilibrium is reached. The slope of such a curve is a measure of the concentration of target in a sample. Examples of such assays for detecting pathogen analytes including the NS1 protein of influenza A or the E6 protein of HPV using PDZ proteins to the PL motifs of these peptides as capture agents and antibodies to other epitopes of these proteins as detection agents (or vice versa) are described in e.g., US20072224594, WO 07/018,843/US 2005255460, WO 07/005,948 and WO2008048276.

The invention provides a device for sensing and reporting the result of a test done on a test strip. With rapid response becoming more important and field work requiring immediate results to study outbreaks of new pathogens, a portable, inexpensive, battery powered strip reader is desirable. The invention includes a method and apparatus that takes advantage of small, inexpensive and durable components. The components may be coupled with comparative algorithms to improve on the accuracy of lateral flow strip tests, and may significantly reduce false positive and false negative results.

In one embodiment, the apparatus is contained in a rectangular package measuring approximately 4×5×8 inches and has a printed circuit board mounted near the top of the package that contains, among other components, two photo-detectors that point down through an optics block. In one embodiment, the optics block is made of black plastic, although other suitable materials may be used. The optics block is attached to the circuit board, for example with screws or other fasteners, and shields the photodetectors from stray light. The lower end of the optics block contains two acrylic spherical lenses that are one half inch in diameter and are held into the block by a plate that also holds four light emitting diodes that are mounted immediately beside the lenses for the purpose of illuminating the test strip. Preferably, the four light emitting diodes are configured in series so that fluctuations in the current passing through them will affect all four similarly. The test strip, contained in this embodiment within a cassette, is placed in a cassette holder capable of holding two cassettes simultaneously. The cassette to be tested is placed in one position and a reference cassette is placed in the other position so the device can comparatively monitor for any fluctuations of light levels due to power or temperature fluctuations, or effects of geometrical changes in the reader resulting from movement of the mechanism. The base of the device contains a mechanically-powered transport mechanism that is activated by the operator by inserting the cassette holder into the device as far as it will travel until stopped. This transport means comprises a plate to receive the cassette holder, a spring that propels the plate in order to push the cassette holder back out of the device, and a damping means, in this case a small hydraulic or pneumatic cylinder, that insures that the cassette holder moves past the optics at a limited rate. The base further contains an encoder that reads an encoder strip that is mounted on the transport means in order to sense the intervals at which the strip should be checked for a result. A bar code detector is mounted below the transport means and is used to identify cassettes as they enter the device in order to allow the device to record results in a traceable manner.

A housing encloses the reader and accommodates connectors for a charging power supply and USB connection as well as a switch for power and an alphanumeric display to show results. A switch for the display backlight is provided to conserve power.

The simplicity of the device and the use of a simple positive or negative result (i.e. presence or absence, compared to a defined threshold by the appropriate algorithm) allow the user to effectively operate the device with little training, thereby reducing operating costs.

In one embodiment, a plastic cassette containing a test strip is placed into one of two wells in a cassette holder. The other well contains a reference cassette for comparison of illumination levels at any time to insure that changes in apparent reflectance levels along the length of the strip is due to actual reflectance differences and not a variation in the light level due to power or temperature fluctuation or to geometrical changes resulting from movement of the transport mechanism. As the cassette holder is inserted into the device, an encoder is moved by the transport mechanism. A photo-detector, within a slotted housing beneath the cassette holder, allows the electronics to read a barcode on the bottom of the cassette through a slot in the bottom of the cassette holder. Once the cassette holder is inserted as far as it will go into the device, the user releases the cassette holder. A spring attached to a sliding member of the transport mechanism propels the cassette holder in a reverse direction and back out of the device at a controlled rate as governed by a damping means acting against the spring. The transport mechanism is thus mechanically-powered, and does not require electrical power. The encoder tracks the motion of the cassette beneath the optical elements and a processing unit interrogates the photo-detectors on the main circuit board every time an encoder state changes. The light level detected by each photo-detector is then recorded in memory. This allows data on reflectance to be graphed by the software and to be adjusted based on readings from the strip within the reference cassette. It further allows the software to compare the reflectance values of the test strip, as corrected for any light fluctuations, to a set of algorithms to determine whether or not the values compare to previously determined parameters in a way that determines whether the test result is positive, negative or invalid. The result is displayed on the alphanumeric display and the raw data, including all reflected light levels at each point along the test strip, are recorded in memory for later download, via the USB port, into a separate computer for further study or comparison to other studies if desired. In other embodiments, the reference photo-detector does not require a separate cassette but reads the light output fluctuations directly from the light source or from a reflective element mounted near the light source. In other embodiments, the one half inch diameter acrylic sphere is replaced by a commercial lens or a sphere of a different diameter, a different material, or both. In some embodiments, the optical path has a greater total length in order to gain higher resolution for tests that require it.

The invention finds use in clinical settings as well as in the field. Its lower cost will make it attractive in settings that may not require the limited size it offers. The fact that it is small, light and battery powered makes it especially attractive to users in rural areas of the world or in military settings that are by their nature, on the move.

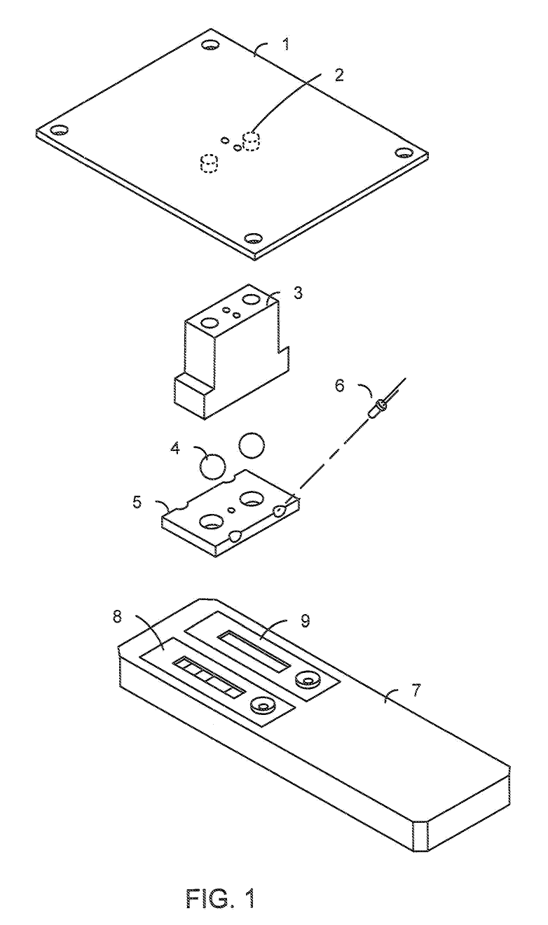

One preferred embodiment of the device is shown in FIGS. 1 through 4D. FIG. 1 shows an exploded view of the optical and electronic components aligned above the cassette holder. A printed circuit board 1 contains most of the circuit elements of the device including a power supply, a processor, memory, a battery, an amplifier circuit, I/O and two photo-detectors 2 that are capable of detecting the specific wavelengths of light most useful in the tests for which the specific reader is used. Photo-detectors 2 may be, for example, model VTB1013BH available from PerkinElmer, Inc., of Waltham, Mass., USA. The photo-detectors are housed within a plastic optics block 3 that is attached to the printed circuit board 1 using two screws, not shown. At the end of the optics block 3 opposite the printed circuit board 1 are two holes that receive lenses 4 that in this embodiment, are clear acrylic spheres, each one half inch in diameter. These lenses 4 are held into the optics block 3 by a plate 5 containing four LEDs 6 for the illumination of the test strips. The plate 5 is attached to the optics block 3 using a screw, not shown. Below the plate 5 is shown a cassette holder 7 that in turn contains a test cassette 8 to be tested, and a reference cassette 9 for the monitoring of light level fluctuations during a test.

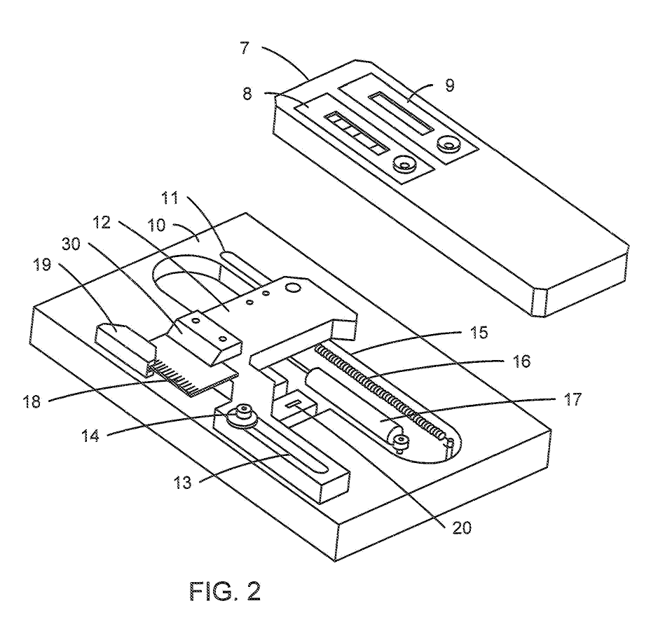

FIG. 2 shows the assembly of the mechanism that transports the cassette holder 7 into and out of the device. A base 10 having a slot 11 supports a spring plate 12 having a slot 13. Two shoulder screws 14 engage the slots (11 and 13) from bottom and top respectively in the base 10 and the spring plate 12 for the purpose of guiding the spring plate 12 in a linear motion when the cassette holder 7 is inserted into the device. A pocket 15 in the base houses a spring 16 and a damper means 17 that together, propel the spring plate 12, and therefore the cassette holder 7 in a direction opposite to its direction of insertion, at a controlled rate that is readable by the optics and logic circuitry. An encoder strip 18 is attached to the spring plate 12 by means of a clamp 30, and is read by the encoder 19 as the spring plate 12 moves. Encoder 19 may be, for example, a model EM1-0-250 available from U.S. Digital of Vancouver, Wash., USA. A barcode reader means 20 is recessed into the base 10 next to the damper means and is used to identify each test cassette 8 by reading a unique bar code label that has been placed on the bottom surface of the test cassette 8. An open slot in the cassette holder 7 beneath the test cassette 8 allows the barcode reader means 20 an optical path to the barcode on the bottom of the test cassette 8.

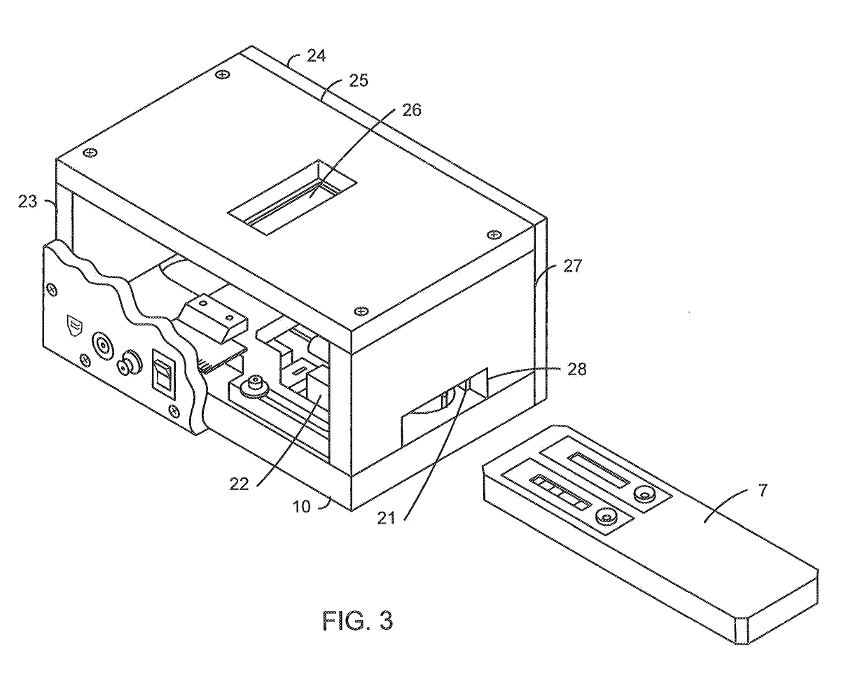

FIG. 3 shows the assembly of the internal components of the device mounted onto the base 10 along with guides 21 and 22 that control the path of the cassette holder 7 as it travels into and out of the device. The cassette holder is positioned as it would be just before entering the reader. The housing in this embodiment is made up of separate plastic plates and comprises four walls and a cover that are held together using screws. A back wall 23 and blank side wall 24 serve only to provide structure and to omit light from the device. A cover 25 contains a display 26 to indicate whether a test is positive, negative or invalid. A front wall 27 having cutout 28 allows for the entry of the cassette holder 7 while keeping ambient light from interfering with the readings of the device. A connector and switch wall 29 contains cutouts to accept power and data connections as well as switches to activate the device and the backlight of the display 26.

The example device is used by switching on the power and inserting a test cassette 8 into the cassette holder 7 and in turn inserting the cassette holder 7 into the cutout 28 of the front wall 27 and pushing the cassette holder into the device. As the test cassette 8 passes over the barcode reader means 20, the barcode containing an identifier on the bottom of the test cassette is read and the identifier is recorded in memory. Once the cassette holder 7 has been pushed into the device as far as it will travel, the cassette holder 7 is released by the user and the spring 16 propels it, via the spring plate 12 in the opposite direction at a speed that is controlled by the damper 17. This motion causes the test strip within the test cassette 8 to pass beneath a lens 4 in the optics block 3 causing any indicating stripes on the test strip to be projected onto the photo-detectors 2 on the circuit board. During this process, the encoder strip 18 is passing through the encoder 19 and causing pulsed signals to be sent to the processor every time the spring plate 12 has progressed one encoder increment (for example, one thousandth of an inch in the example embodiment). Upon each encoder pulse, the processor interrogates the photo-detectors 2 and enters a value into memory for both the test cassette 8 and the reference cassette 9.

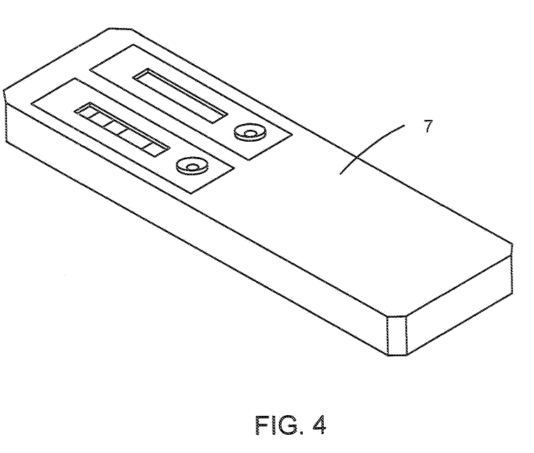

FIGS. 4A through 4D show a schematic diagram of the electronic circuit of the device, in accordance with an example embodiment of the invention. In this example, operation of the reader is controlled by a model PIC18F6527 microcontroller available from Microchip Technology, Inc., of Chandler, Ariz., USA. Of course, any other suitable microcontroller or microprocessor system may be used.

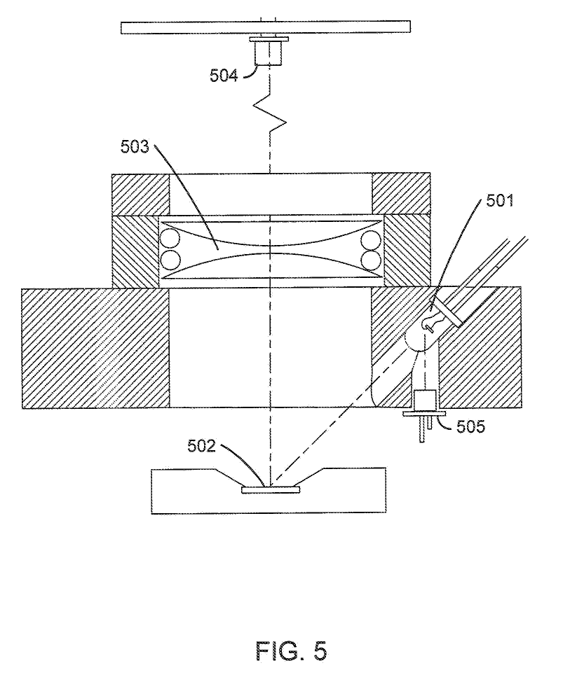

FIG. 5 shows an optical path for a strip reader in accordance with another example embodiment of the invention. In the configuration of FIG. 5, no reference strip is needed. A light source 501 illuminates a strip under test 502. In the example shown, light source 501 is a light emitting diode, but other kinds of light sources may be used. At least some of the light reflected from strip 502 passes through lens system 503. In this example, lens system 503 comprises two plano-convex lens elements made of glass, plastic, or other suitable material. Other lens arrangements may be used having different numbers or kinds of elements. For example, the simple ball lenses shown in the embodiment of FIG. 1 may be used in this embodiment as well.

At least some of the light passing through lens system 503 reaches a sensor 504. Sensor 504 may be, for example, a VTB1013BH Process Photodiode available from PerkinElmer, Inc., of Waltham, Mass., USA, or another kind of sensor. Sensor 504, possibly in conjunction with support electronics, provides an electrical signal indicative of the brightness of the light reaching it. In one example embodiment, the signal is a voltage proportional to the amount of light striking sensor 504. The voltage can be converted to a digital value using an analog-to-digital converter.

A second sensor 505 is mounted with a direct view of light source 501. Sensor 505 thus reads the brightness of light source 501 directly. Light source 501 is the same light source that is illuminating strip 502, so sensor 505 obtains a direct reading of the amount of light being supplied to strip 502. No reference strip or additional light sources are required to obtain calibration information. In one example embodiment, sensor 505 is identical to sensor 504, and provides a signal that can be digitized by circuitry similar that shown in FIGS. 4A-4D. Any variation in the brightness of light source 501 is detected and can be compensated by making compensating adjustments to the digital values obtained via sensor 504. For example, if at some point in a test sensor 505 indicates that light source 501 has dimmed by 10 percent since the beginning of a test, digital values obtained via sensor 504 at that point in the test may multiplied by (1/0.9) so that the reflectance of strip 502 is accurately noted and the recorded digital values are not affected by variations in the light output of light source 501. Alternatively, an algorithm used to analyze the test data may accommodate illumination variations in some other way. The output signals of the two sensors may be separately scaled using analog circuitry or adjustment of digital values derived from the two signals.

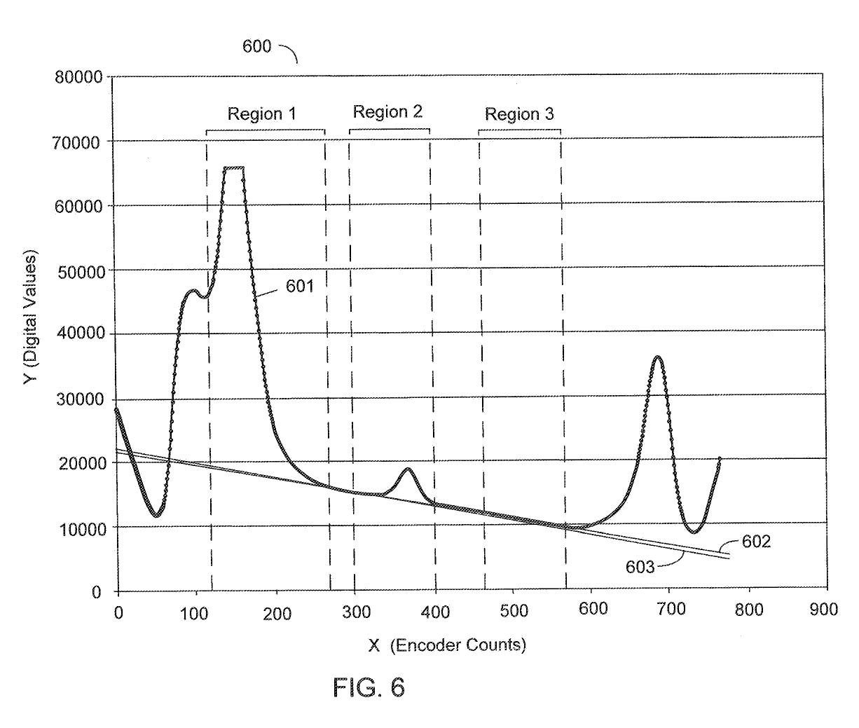

FIG. 6 shows an example graphical representation 600 of test data gathered from a test strip by a reader according to an example embodiment of the invention. This particular graph shows data gathered from a test strip designed to test for two kinds of influenza. A test trace 601 records digital values read from the strip under test, and represents the reflectance of the test strip, shown on the Y axis, as a function of distance along the test strip, shown in the X axis. The result of the test is indicated by the existence and relative heights of peaks in certain regions of trace 601, corresponding to parts of the strip containing chemically sensitive materials. Each peak indicates the existence of a line of lowered reflectance on the strip under test. In this example, a higher reflectance results in a lower Y value, and a lower reflectance results in a higher Y value, although the opposite arrangement may be used. The full scale Y value in this example is about 65,000 digital counts, but one of skill in the art will recognize that this scaling is entirely arbitrary. In FIG. 6, the X axis is graduated in counts of the encoder, and this scaling is also arbitrary.

A linear second trace 602 is fit to points on trace 601 read from areas of the test strip that do not have chemically sensitive materials that may form lines, and therefore trace 602 represents a “baseline” reflectance of the test strip. A second baseline 603 is fit to other points where lines of lowered reflectance are not expected, and provides a second baseline that may be used to increase the confidence in the test result. Peak heights may be measured from one or more of the baselines.

In the example of FIG. 6, three regions of interest are investigated, corresponding to X-axis positions 120-270 (region 1, covering a control line on the test strip), 300-400 (region 2, covering a Flu A line on the test strip), and 460-560 (region 3, covering a Flu B line on the test strip). In this example, peaks are apparent in regions 1 and 2, but no peak is discernable in region 3. This combination indicates the presence of influenza A and the absence of influenza B.

Various data smoothing, peak finding, or other data filters may be applied during the analysis of the digital values.

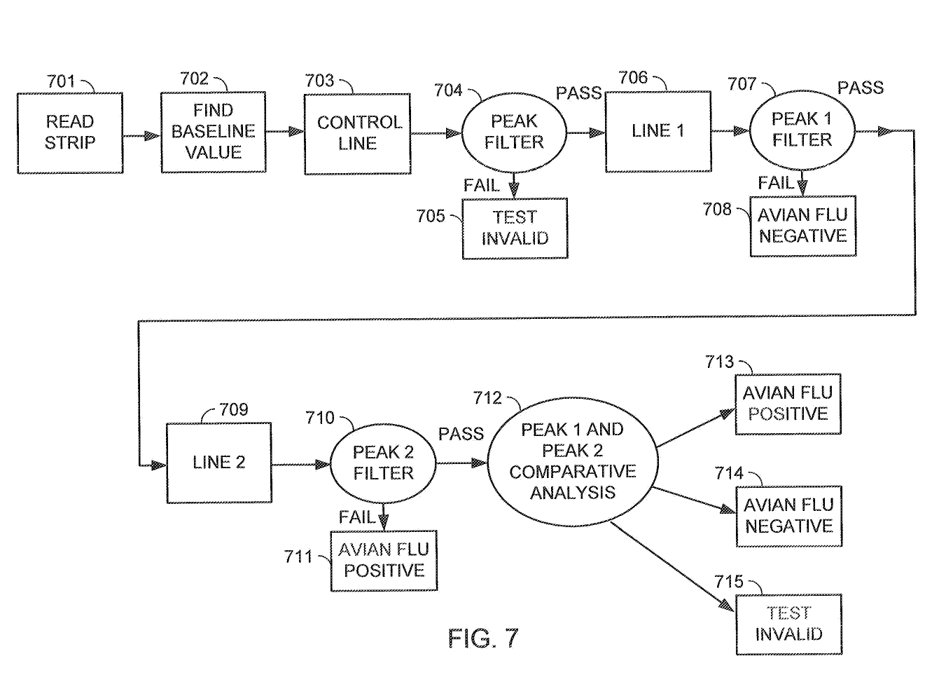

In another example embodiment, a test strip designed to detect the presence or absence of avian influenza may be read and interpreted. A flowchart of the process for reading an avian influenza test strip is shown in FIG. 7. In step 701, the test strip is read, and in step 702, a baseline value is determined. In steps 703 and 704, a region of the test strip corresponding to a control line is analyzed. If peak filter 704 fails (for example, no peak is found, or a peak of an incorrect height is found), the test is determined to be invalid and that result is communicated in step 705. If a valid control peak is found, a region of the test strip corresponding to a first line is analyzed in steps 706 and 707. If the conditions of peak filter 707 indicate that the test result is negative, that result is communicated in step 708. As the test continues, a region of the test strip corresponding to a second line is analyzed in steps 709 and 710. If the conditions of peak filter 710 indicate that the test result is positive, that result is communicated in step 711. If the test results are not yet ascertained, then a comparative analysis is performed at step 712, and a positive or negative result is communicated at step 713 or 714, depending on the result of the comparative analysis. The comparative analysis may also reveal that the test is invalid, which is reported in step 715.

More details about the processing performed in the various steps shown in FIG. 7 are described below. These details assume similar ranges of values in the X and Y axes of a chart similar to that of FIG. 6. One of skill in the art will recognize that data scaled differently may be used, with appropriate adjustments to the number thresholds used in the analyses.

The baseline value determined in step 702 is the minimum Y value recorded between X values of 200 and 750.

The test is determined to be invalid in steps 703-705 if either 1) in the range of X values between 140 and 270, no Y value exceeds the baseline by 1850 counts or more, or 2) the local maximum Y value found between steps 140 and 270 is not at least 100 counts higher than either of the Y values found 70 steps either side of this local maximum Y value.

The analysis of line 1 (steps 706-708) takes place in a region between X values of 325 and 450. The test is determined to be negative if either 1) no Y value in this region exceeds the baseline by 1850 counts or more, or 2) the local maximum Y value found in this region is not at least 1000 counts higher than either of the values read 70 steps either side of this local maximum. If neither of these conditions is met (the test has not been determined to be negative), the outcome of the test is not yet ascertained. The first peak height (above the baseline value) is recorded for later use.

The analysis of line 2 (steps 709-711) takes place in a region between X values of 600 and 725. The test is determined to be positive if the local maximum Y value in this region does not exceed baseline value by at least 1850 counts. The test is also determined to be positive (when the local maximum is more than 1850 counts above the baseline value) if the local maximum value in this region is not at least 1000 counts higher than either of the values read 70 counts either side of this local maximum. If the test is not determined to be positive, the outcome is not yet determined, and second peak height (above the baseline value) is recorded for later use.

The comparative analysis (steps 712-715) operates on the first and second peak heights previously recorded. If both the first and second peak heights exceed the baseline value by 45,000 counts or more, the test is invalid. If the first peak height is less than 30,000, and the first peak height is at least three times the second peak height, the test is determined to be positive. If the first peak height is less than 30,000, and the first peak height is less than three times the second peak height, the test is determined to be negative. If the first peak height is more than 30,000 and both peak heights are less than 45,000, then the first and second peak heights are compared and the test is determined to be 1) positive if the first peak height is higher than the second peak height, and 2) negative otherwise. If the first peak height is greater than 45,000 and the second peak height is less than 45,000, the test is determined to be positive. If the first peak height is less than 45,000 and the second peak height is greater than 45,000, the test is determined to be negative.

The example of FIG. 7 illustrates the basic principles of test strip interpretation. Other tests may produce test strips with different numbers of lines (and regions to analyze), and the results of those tests may be interpreted by application of a different set of rules.

It is understood that the examples and embodiments described herein are for illustrative purposes only and that various modifications or changes in light thereof will be suggested to persons skilled in the art and are to be included within the spirit and purview of this application and scope of the appended claims.

For example, while the system of FIG. 1 has been illustrated as using four light emitting diodes as light sources, other quantities and kinds of light sources may be used, such as one or more fluorescent lamps, incandescent lamps, or other sources. Preferably, the light source is selected to emit light with wavelengths that will reveal significant contrast in the test strip being read as sensed by the light sensor or sensors. For example, if a particular test checks for the presence or absence of a red stripe on an otherwise white background, green light emitting diodes may be an appropriate light source, as the white background will reflect most of the green light, while the red stripe will reflect less.

In another example, the housing depicted in the example embodiment shown in the drawings is made of separate plastic plates. In other embodiments, the housing may be made of one or more injection molded plastic parts, folded sheet metal parts, die-cast parts, or parts made by other processes and connected using screws, bolts, snap fits, adhesives, or other suitable fastening methods.

While an alphanumeric display has been described, other kinds of result indicators may be used. For example, the reader may comprise a backlit liquid crystal display, a reflective liquid crystal display, a display forming characters using light emitting diode segments, or other kinds of displays. Alternatively, the display may be configured to display more than simply a test result, and may allow display of the reflectance data from a test in graphical form. Or a result indicator may be as simple as one or more lights that indicate a positive or negative test result. For example, a reader may simply illuminate a red light to indicate a negative result and illuminate a green light to indicate a positive result. Many other configurations are possible.

The circuit schematic in FIGS. 4A-4D shows but one example of a circuit for controlling a reader in accordance with an example embodiment of the invention. Many other circuit configurations are possible, using any of many kinds of processors, memory, analog circuits, digital circuits, and the like.

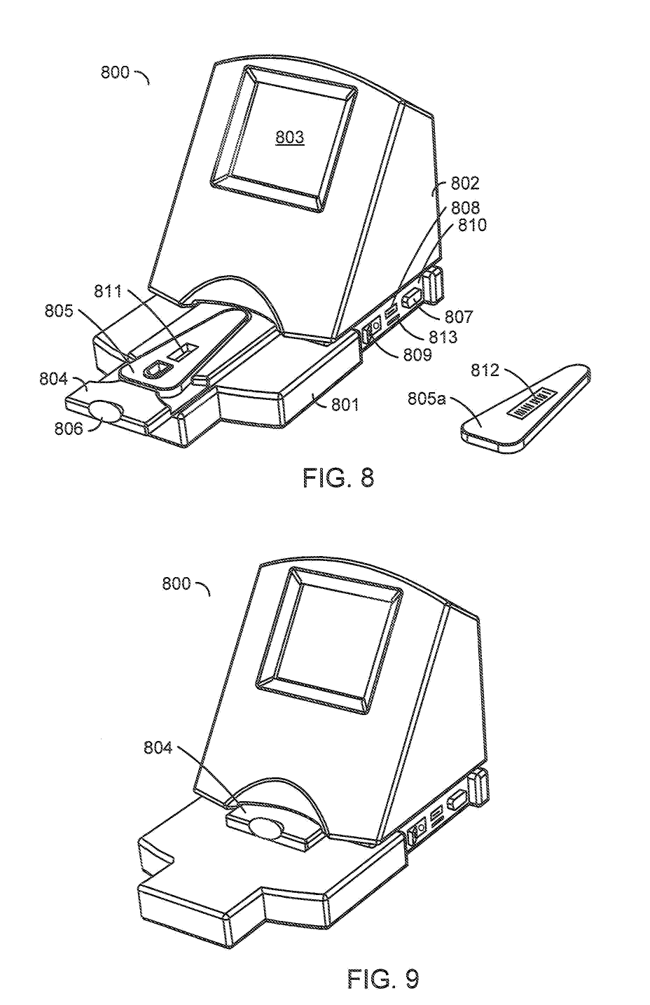

FIGS. 8-11 show a test strip reader 800 in accordance with another example embodiment of the invention.

FIG. 8 shows the external appearance of the reader in accordance with this embodiment. The reader comprises a base portion 801 and an upper portion 802. Upper portion 802 includes a display 803, which may be, for example, a touch screen display capable of displaying data, text, images, and other kinds of output, and also capable of receiving user input via touches on the surface of the display 803. In one embodiment, display 803 can display 128×128 pixels. Display 803 may be a reflective liquid crystal display (LCD), a backlit LCD, or another kind of display. Display 803 is positioned at an angle from horizontal for easy viewing by a user of reader 800. For example, display 803 may be positioned at an angle between 30 and 60 degrees from horizontal, and preferably at an angle between 40 and 50 degrees.

Base portion 801 includes a sliding cassette holder or tray 804, which is shown holding a cassette 805. Cassette 805 includes a test strip 811, which is to be read by reader 800. Preferably, cassette 805 also includes a bar code on its bottom side for identification purposes as has been previously described. Also shown in FIG. 8 is a second cassette 805a, inverted to show its bottom side, which includes a bar code 812. Preferably, tray 804 is sized to accommodate cassettes of various sizes and from different test manufacturers. Tray 804 may include a pushing surface 806, upon which a user may conveniently push when inserting the tray and cassette into the reader so that a test can be performed. FIG. 9 shows test strip reader 800 with the tray 804 and cassette 805 fully inserted. (Cassette 805 is not visible in FIG. 9.)

Base portion 801 may comprise one or more electrical connectors, switches, card slots, or other devices for controlling, communicating with, or adding capabilities to the reader. Example reader 800 includes an RS-232 serial port connector 807, a universal serial bus (USB) connector 808, and a power switch 809, all located in recessed connector panel 810. Merely by way of example, an external printer may be connected to the RS-232 port so that test results or other information can be printed. A computer may be connected to the USB port for downloading firmware upgrades or other data to the test strip reader 800, retrieving stored test data from reader 800, or other uses. Many other kinds of interfaces may be used, to communicate with these and other kinds of devices. A memory card slot 813 may be positioned on connector panel 810, or at another location. For example, memory card slot 813 may accept a removable solid state memory card, such as a flash memory card. Reader 800 may store test data or results in the memory card, and the card may be moved to a computer or other device for retrieval of the data.

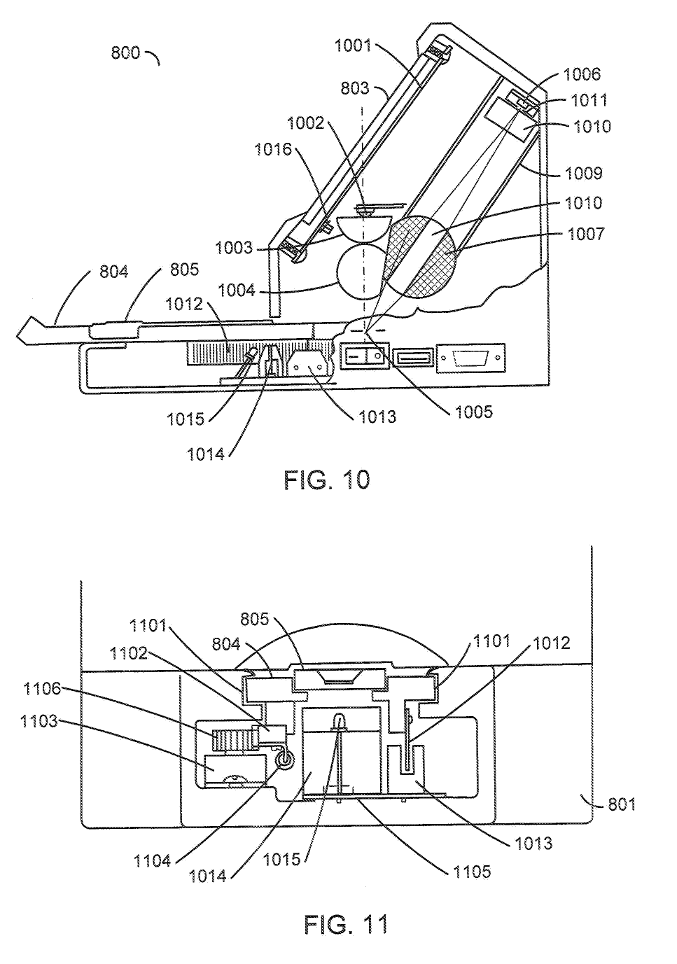

FIG. 10 shows a cutaway side view of example reader 800. A main printed circuit board 1001 is mounted directly behind display 803. Of course, other mounting positions may be used. Main circuit board 1001 may comprise a control circuit similar to that shown in FIGS. 4A-4D. The control circuit preferably includes a microprocessor and associated support circuitry, such as any needed memory, clock, input/output or other circuitry. Alternatively, a single-chip microcontroller may be used. In one example, embodiment, a PIC24FJ256GA110 microcontroller available from Microchip Technology, Inc., of Chandler, Ariz., USA, may be used. The control circuit also preferably includes driving circuitry for displaying data and receiving input from touch screen display 803, circuitry for communicating over various input/output interfaces, such as RS-232 port 807 and USB port 808, and circuitry for controlling, reading, and communicating with the various other components of the reader discussed below.

One of skill in the art will recognize that various cabling and connectors may be used to interconnect the various reader components and subsystems. The cabling and connectors have been omitted from the figures for clarity of illustration. The electronic circuitry of reader 800 preferably receives power from a battery or an external power source. The battery may be a rechargeable battery, rechargeable from an external power source, and the reader may be configured to operate on battery power alone, or from the external power source while the battery is recharging. These power subsystems have also been omitted from the drawings, in the interest of clarity. One of skill in the art will recognize how to integrate them with a reader such as reader 800.

During reading of a test strip, a light source such as light emitting diode (LED) 1002 emits light to illuminate the test strip at reading location 1005. LED 1002 may be, for example, a model LedEngin LZ1-00G105 distributed by Mouser Electronics, producing light at a primary wavelength of about 536 nanometers. Other kinds and colors of light sources may also be used. In example reader 800, an illumination optical system directs light from LED 1002 to the test strip, to improve the illumination level at the test strip. In one embodiment, the illumination optical system comprises a plano-convex lens 1003 and a spherical lens 1004. (Even though part of lens 1004 is cut away for assembly purposes, lens 1004 is still considered to be a spherical lens because its primarily functional surfaces are portions of a sphere.) Plano-convex lens 1003 may be a hemispherical lens. The radii of the curved surfaces of lenses 1003 and 1004 may be, for example about 12.7 millimeters (½ inch). The lenses may be made of glass, plastic, or any other suitable material. Other kinds of optical systems may be used for concentrating light from LED 1002 onto the test strip being read, including lenses, reflectors, and other kinds of optical elements, alone or in any combination.

The intensity of the reflected light is an indication of the reflectance of the test strip at reading location 1005. Some of the light reflected from the test strip reaches a first sensor 1006, which, possibly in conjunction with support electronics, produces a signal indicating the intensity of light falling on it. First sensor 1006 may be, for example, a VTB1013BH Process Photodiode available from PerkinElmer, Inc., of Waltham, Mass., USA, or another kind of sensor. In one example embodiment, the signal is a voltage proportional to the amount of light striking sensor 1006. The voltage can be converted to a digital value using an analog-to-digital converter.

A reading optical system may be used to direct some of the light reflected from the test strip to first sensor 1006. In example reader 800, a spherical lens 1007 helps gather and redirect light from reading location 1005. (Part of lens 1007 may be cut away for assembly purposes, but lens 1007 may still be considered to be a spherical lens because its primarily operative surfaces are portions of a sphere.) Lens 1007 may have a radius, for example of about 19.05 millimeters (¾ inch), and may be made of glass or plastic. Other kinds of lenses may be used, for example a system similar to the two plano-convex elements in lens system 503 discussed above, or another kind of lens system. In one example embodiment, a lens system similar to lens system 503 may include lens model numbers ASR-038-03 and ASR-0805, made of poly methyl methacrylate (PMMA), and available from Align Optics or from Anson Optical. The portion of lens 1007 that is used to direct light may be limited to a transmission band 1008 around lens 1007. Preferably, the portion of lens 1007 in transmission band 1008 has a polished surface. Transmission band 1008 may be, for example, about 12.7 millimeters (½ inch) wide and may girdle lens 1007 at the optical axis of the reading optical system. The remainder of the surface of lens 1007 may be configured to reduce stray light reflections, and is preferably given a matte finish, and covered with a light-absorbing coating, such as black paint.

One or more baffles or other devices such as tube 1009 (shown in cross section) may be included for further reducing stray light reflections that may detrimentally affect the reading of first sensor 1006. In reader 800, a second lens 1010 is also included. Lens 1010 is a semi-cylindrical lens, shown with its axis cross-ways to the viewing direction of FIG. 10. The curved surface of lens 1010 may have a radius, for example, of about 10 millimeters. Additionally, a small aperture 1011 may be placed immediately in front of sensor 1006, between lens 1010 and first sensor 1006. For example, a slit aperture with a width of about 0.75 millimeters (0.030 inches) may be molded into an opaque plastic part that resides in front of first sensor 1006.

During reading of a test strip, the signals from sensors 1006 and 1016 are repeatedly read by the microprocessor while the test strip is transported through the reader and past reading location 1005. A second sensor 1016 produces a signal indicative of the intensity of LED 1002. Second sensor 1016 may be the same kind of sensor as first sensor 1006, or another kind of sensor. Light from LED 1002 reaches second sensor 1016 directly, and therefore second sensor 1016 serves as a light monitor. Here, “directly” means that light from LED 1002 reaches second sensor 1016 without first reflecting from the test strip under test or from a calibration or monitor strip. At least some of the light reaching second sensor 1016 may reflect from stationary surfaces, refract through certain elements of reader 800, or reach sensor 1016 in some circuitous way and still be considered to have been received directly. Readings from second sensor 1016 are taken in concert with the readings from first sensor 1006, and used to adjust the readings from first sensor 1006 to account for variations in the intensity of LED 1002.

Cassette holder or tray 804 preferably includes an encoder strip 1012, configured to pass through encoder reader 1013 during motion of tray 804. Encoder strip 1012 may be, for example, a thin, flat metallic strip with regularly-spaced linear openings through it, or may be a clear plastic strip with opaque lines applied photographically. Encoder reader 1013 includes a light source and a detector on opposite sides of encoder strip 1012, and senses the alternate blocking and passing of light from the light source to the detector as encoder strip 1012 passes. Alternatively, encoder strip 1012 may have a contrasting pattern printed on an opaque material, and encoder reader 1013 may read encoder strip 1012 entirely from one side. Encoder strip 1012 may include enough slits or lines so that a pulse or state change occurs every 0.004 inches (0.1 millimeters), every 0.001 inches (0.025 millimeters), or another suitable travel distance of encoder strip 1012. For example, encoder strip 1012 may include lines or slits 0.008 inches (0.20 millimeters) wide every 0.016 inches (0.40 millimeters), from which a quadrature reader produces a state transition every 0.004 inches (0.10 millimeters). Signals from encoder reader 1013 are passed to the microprocessor, which uses the encoder signal to determine when to take light intensity measurements. For example, light intensity measurements may be taken each time a change in state of the encoder signals occurs, every other time, every third or fourth time, or at some other regular or irregular interval. Sensors 1006 and 1016 may be read at the same or different transport mechanism positions. Other kinds of encoders or position indication means may also be used, for example a rotary encoder. Alternatively, tray 804 may be driven with a stepper motor, and a count of the step position of the motor may serve as a position indicator.

Test strip reader 800 may also include a bar code reader 1014 and an associated bar code illuminator 1015. Bar code illuminator 1015 may be, for example, a light emitting diode (LED) that illuminates the bottom side of cassette 805 as it passes, and bar code reader 1014 may be any suitable optical detector for reading the bar code from the bottom of cassette 805. Signals from bar code reader 1014 are preferably also passed to the microprocessor, so that the bar code information can be correlated with the results of the test.

FIG. 11 shows an end view of the transport mechanism and other components in base portion 801. The transport mechanism preferably is a passive mechanical system including a spring 1104 and a damper 1103. In a preferred embodiment, a user pushes tray 804 carrying cassette 805 into reader 800. Tension spring 1104 resists the motion, and is elongated during the inward motion. Once tray 804 is fully inserted, the user may release it to be pulled back out of reader 800 by spring 1104. Tray 804 is constrained to move in a linear motion by mechanical guides 1101. Encoder strip 1012 is attached to one side of tray 804. Attached to another side of tray 804 is a gear rack 1102. During motion of tray 804, gear rack 1102 actuates rotary damper 1103 through pinion gear 1106, engaged with rack 1102. Spring 1104 is placed to pull tray 804 outward from reader unit 800. Rotary damper 1103 resists motion of tray 804, and limits the speed at which spring 1104 can pull tray 804 out. Bar code reader 1014 and bar code illuminator 1015 are positioned under tray 804, and attached to a bar code and encoder circuit board 1105. Bar code and encoder circuit board 1105 communicates with main circuit board 1001 so that the microprocessor can monitor the position of tray 804 and can read the bar code from the bottom of cassette 805.

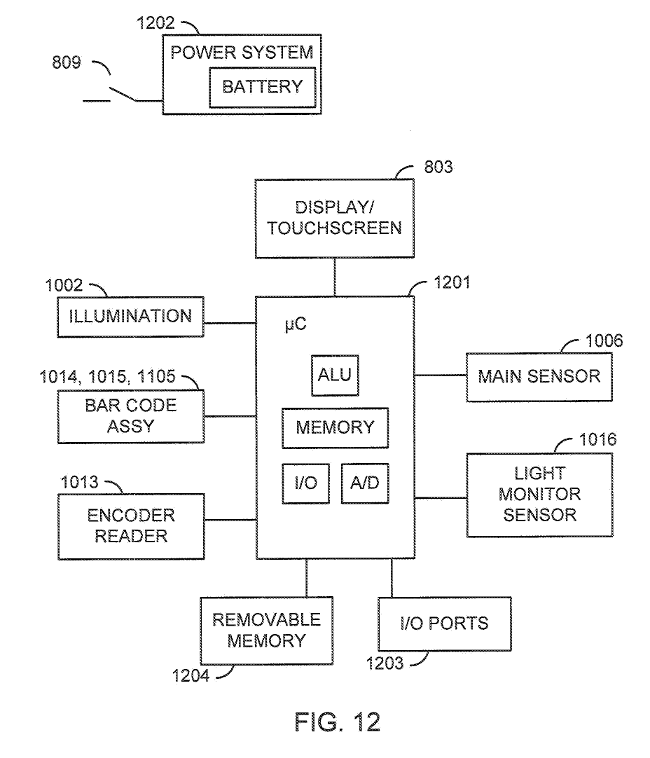

FIG. 12 illustrates a simplified block diagram of the electrical and electronic systems of reader 800. A microprocessor or microcontroller 1201 provides control, computation, and user interface functions for the system. Microcontroller 1201 may include an arithmetic logic unit (ALU), memory, and input/output circuitry, including one or more analog-to-digital converters (A/D). The memory may comprise various kinds of memory in any suitable combination, including volatile memory such as random access memory (RAM), nonvolatile memory such as read only memory (ROM), flash memory, programmable read only memory (PROM), erasable programmable read only memory (EPROM), and electrically erasable programmable read only memory (EEPROM), and may also include long term storage devices.

Microcontroller 1201 interfaces with touch screen display 803 to communicate with the user of reader 800, receive commands, display test results, and provide other functions. Microcontroller 1201 controls the operation of main illumination LED 1002. Microcontroller 1201 also communicates with encoder reader 1013, and the components associated with reading bar codes from a cassette, so that microcontroller 1201 can monitor the progress of tray 804 through reader 800, and can associate the bar code read from a cassette 805 with a test result. Microcontroller 1201 also takes readings from first light sensor 1006, reading light reflected from the test strip, and takes readings from second sensor 1016, reading the intensity of LED 1002 directly. Microcontroller 1201 uses the readings from the light monitor sensor 1016 to adjust readings from the main sensor 1006 to account for variations in the intensity of the light supplied to the test strip. Microcontroller 1201 also interfaces with various input/output ports 1203, such as RS-232 serial port 807, USB port 808, and any other ports provided. Microcontroller 1201 may also communicate with removable memory 1204, which may be, for example a removable card containing flash memory or the like.

A power subsystem 1202 provides power to microcontroller 1201 and the various other devices and systems through connections not shown. Power system 1202 may include a battery, so that reader 800 may be operated in a remote location. The battery may be rechargeable.

It will be understood that certain steps in methods described herein may be performed by a computer, microprocessor, microcontroller, or other processor executing a stored program stored on a computer readable medium. A computer readable medium may comprise memory such as random access memory (RAM), read only memory (ROM), flash memory, erasable programmable read only memory (EPROM), volatile memory, nonvolatile memory, or the like, or combinations of these. A computer readable medium may comprise mass storage, such as a compact disc read only memory (CD-ROM), a digital versatile disk (DVD), magnetic storage, magneto-optic storage, or the like, or combinations of these.

All publications, patents and patent applications cited herein are hereby incorporated by reference in their entireties for all purposes to the same extent as if each individual publication, patent or patent application were specifically and individually indicated to be so incorporated by reference. Unless otherwise apparent from the context any feature, embodiment, element, or step can be used in combination with any other.

1. A test strip reader, comprising:
a light source that illuminates at least part of a test strip;
a transport mechanism that moves the test strip past the light source, the transport mechanism further comprising a spring that propels the test strip and a damping mechanism that limits the speed of transport;
a sensor that produces a signal indicating the intensity of light reflected from the test strip;
electronic circuitry configured to repeatedly measure the signal from the sensor and to produce for each measurement a digital value representing the reflected light intensity;
a processor configured to determine, based on the digital values, a test result.

2. The test strip reader of claim 1, wherein the sensor is a first sensor, the test strip reader further comprising a second sensor that produces a signal indicating the brightness of the light source, and wherein the electronic circuitry is further configured to also measure the signal from the second sensor and to adjust the digital values to compensate for variability of the brightness of the light source.

3. The test strip reader of claim 2, wherein the second sensor senses the brightness of the light source directly.

4. The test strip reader of claim 2, wherein the second sensor senses the intensity of light reflected from a reference strip.

5. The test strip reader of claim 4, wherein the reference strip is also moved by the transport mechanism.

6. The test strip reader of claim 1, further comprising a battery, and wherein the electronic circuitry is powered using energy from the battery.

7. The test strip reader of claim 1, further comprising an indicator that indicates the test result.

8. The test strip reader of claim 1, further comprising an encoder that indicates progress of the transport mechanism by producing a series of position-indicating signals related to the position of the transport mechanism, and wherein the measurements of light intensity signal occur upon receipt by the electronic circuitry of at least some of the position-indicating signals.

9. The test strip reader of claim 1, further comprising a bar code reader that reads a bar code from a cassette holding the test strip.

10. The test strip reader of claim 9, wherein the test strip and the bar code reside on opposite sides of the cassette.

11. The test strip reader of claim 1, further comprising a display upon which test results are displayed.

12. The test strip reader of claim 11, wherein the display is a liquid crystal display.

13. The test strip reader of claim 11, wherein the display is a touch screen display.

14. The test strip reader of claim 1, further comprising at least one input/output port connector.

15. The test strip reader of claim 14, wherein the electronic circuitry further comprises a memory in which test data are stored for later communication to an external computer system via at least one input/output connector.

16. The test strip reader of claim 11, further comprising a removable memory into which test data are stored.

17. The test strip reader of claim 1, wherein a reading optical system directs light reflected from the test strip to the sensor.

18. The test strip reader of claim 17, wherein the reading optical system comprises at least one lens element.

19. The test strip reader of claim 17, wherein the reading optical system comprises at least one spherical lens element.

20. The test strip reader of claim 19, wherein the spherical lens element comprises a transmission band having a polished surface, and wherein the remainder of the surface of the spherical lens element is configured to reduce stray light reflections.

21. The test strip reader of claim 20, wherein the remainder of the surface of the spherical lens element has a matte finish and is covered with a light-absorbing coating.

22. The test strip reader of claim 17, wherein the reading optical system further comprises a semi-cylindrical lens proximate the sensor.

23. The test strip reader of claim 1, further comprising an aperture placed immediately in front of the sensor.

24. The test strip reader of claim 23, wherein the aperture is a slit aperture having a width of between 0.025 inches and 0.035 inches (0.64 millimeters and 0.89 millimeters).

25. The test strip reader of claim 1, wherein the damping mechanism is a rotary damper.

26. The test strip reader of claim 1, wherein the light source illuminates the test trip from a direction substantially perpendicular to the test strip surface.

27. A test strip reader, comprising:
a light source that illuminates at least part of a test strip;
a mechanically-powered transport mechanism that moves the test strip past the light source;
electronic circuitry comprising a processor and configured to repeatedly measure a quantity of light reflected from the test strip, to produce for each measurement a digital value representing the measured light quantity, and to determine a test result based on the digital values; and
a battery that supplies power to the light source and electronic circuitry.

28. A method of ascertaining a test result, comprising:
receiving a test strip to which a test fluid has been applied;
reading the reflectance of the test strip at multiple locations along the test strip by mechanically transporting the test strip past a reading location in a battery-powered test strip reader;
recording a digital value for each reflectance reading;
ascertaining a peak or minimum reflectance value in each of one or more regions of the test strip;
comparing the peak or minimum reflectance values with a predetermined set of interpretation rules to determine the test outcome; and
communicating the test outcome.

29. The method of claim 28, wherein transporting the test strip further comprises moving a tray carrying the test strip under the action of a spring, the method further comprising limiting the speed of transport by a mechanical damper actuated by motion of the tray.

30. The method of claim 28, wherein reading the reflectance of the test strip further comprises:
illuminating the test strip; and
reading an intensity of light reflected from the test strip.

31. A test strip reader, comprising:
a base portion housing a mechanical transport mechanism including a spring and a damper;
an upper portion housing an illumination source that illuminates a test strip under test, a sensor that detects light reflected from the test strip, an electronic circuit that controls operation of the test strip reader, and a display on which test results are shown to a user of the test strip reader;
wherein the test strip under test resides above the base portion, and is transported by the transport mechanism beneath the light source during reading of the test strip.

32. The test strip reader of claim 31, wherein the display is positioned at an angle of between 30 and 60 degrees from horizontal.

33. The test strip reader of claim 31, further comprising an encoder that produces signals indicating a position of the transport mechanism, and wherein the intensity of the light reflected from the test strip is measured upon receipt by the electronic circuit of at least some of the position-indicating signals.

34. The test strip reader of claim 31, wherein the display is a touch screen display.

35. The test strip reader of claim 31, further comprising a movable tray that holds a cassette, which in turn holds the test strip under test.

36. The test strip reader of claim 35, wherein the movable tray is configured to accommodate cassettes of different sizes and from different test manufacturers.

37. The test strip reader of claim 35, further comprising:
a gear rack on the movable tray; and
a rotary damper in the base portion including a pinion gear;
wherein the gear rack engages the pinion gear during reading of the test strip.

38. The test strip reader of claim 31, further comprising a bar code reader in the base portion, wherein the barcode reader reads a barcode from a cassette that holds the test strip in con unction with reading of the test strip.

39. The test strip reader of claim 31, wherein the light source is a light emitting diode.

40. The test strip reader of claim 31, further comprising an illumination optical system that enhances the level of illumination of the test strip.

41. The test strip reader of claim 40, wherein the illumination optical system comprises at least one spherical lens element and at least one hemispherical lens element.

42. The test strip reader of claim 31, further comprising a reading optical system that directs at least some of the light reflected from the test strip to the sensor.

43. The test strip reader of claim 42, wherein the reading optical system comprises at least one spherical lens element.

44. The test strip reader of claim 42, wherein the reading optical system comprises at least one semi-cylindrical lens element.

45. The test strip reader of claim 31, wherein the sensor is a first sensor, and further comprising a second sensor that senses illumination from the light source directly, and wherein the electronic circuit is configured to adjust measurements of reflected light taken from the first sensor, based on direct measurements of light intensity taken from the second sensor, to compensate for variations in the intensity of the light source during reading of the test strip.

46. The test strip reader of claim 31, further comprising a battery that powers the electronic circuitry.

47. The test strip reader of claim 31, wherein the electronic circuitry is configured to repeatedly take measurements of the light reflected from the test strip during reading of the test strip, convert the measurements to digital values, and to apply a predetermined set of interpretation rules to the digital values in order to determine a test result.

48. The test strip reader of claim 31, wherein the electronic circuitry comprises removable memory in which test data are stored.
